(19) United States
(12) Patent Application Publication
(10) Pub. No.: US 2002/0044442 A1
(43) Pub. Date: Apr. 18, 2002

(54) Writing apparatus

(76) Inventor: Robert Brown, Sun Valley, CA (US)

Correspondence Address: Matthew J. Peirce, Esq., 1550 Starlight Canyon Avenue, Las Vegas, NV, 89123, US

(21) Appl. No.: 09/949,176

(22) Filed: Sep. 7, 2001

Related U.S. Application Data
(60) Provisional application No. 60/231,204, filed on Sep. 8, 2000.

(51) Int. Cl. B43K 29/10

(52) U.S. Cl. 362/118; 362/208

(57) ABSTRACT

A new and improved writing apparatus is disclosed that will assist a user in using a writing utensil while it is dark or there is insufficient light. The present invention would comprise a writing utensil and an attached flashlight. The writing utensil would preferably be a pen, but a pencil could also be utilized. The writing utensil would have two ends, a writing end and a terminal end. The flashlight would be located in a thin tube which would have two ends, a first end and a second end. The first end of the thin tube of the flashlight would be located near the writing end of the writing utensil and would have a light attached. The second end of the thin tube of the flashlight would be located near the terminal end of the writing utensil and would have an on/off push button switch. The flashlight would be powered by an internal battery which would be located in either the writing utensil or the thin tube.

### BACKGROUND OF THE INVENTION

The present invention is that of a new and improved writing apparatus that will assist a user in using a writing utensil while it is dark or there is insufficient light.

### DESCRIPTION OF THE PRIOR ART

U.S. Pat. No. 5,803,583, issued to Hsieh, discloses a pen with a light source that has a head member with a bulb connected thereto and an adjusting assembly and batteries mounted in tube members.

U.S. Pat. No. 3,384,742, issued to Delligatti, discloses a ballpoint pen which has a self-contained light source comprising a hollow plastic cylindrical barrel having first and second parallel bores.

U.S. Pat. No. 1,222,948, issued to Hawthorne, discloses a marketing implement combined with illuminating means.

### SUMMARY OF THE INVENTION

The present invention is that of a new and improved writing apparatus that will assist a user in using a writing utensil while it is dark or there is insufficient light. The present invention would comprise a writing utensil and an attached flashlight. The writing utensil would preferably be a pen, but a pencil could also be utilized. The writing utensil would have two ends, a writing end and a terminal end. The flashlight would be located in a thin tube which would have two ends, a first end and a second end. The first end of the thin tube of the flashlight would be located near the writing end of the writing utensil and would have a light attached. The second end of the thin tube of the flashlight would be located near the terminal end of the writing utensil and would have an on/off push button switch. The flashlight would be powered by an internal battery.

There has thus been outlined, rather broadly, the more important features of a writing utensil in order that the detailed description thereof that follows may be better understood and in order that the present contribution to the art may be better appreciated. There are, of course, additional features of the writing utensil that will be described hereinafter and which will form the subject matter of the claims appended hereto.

In this respect, before explaining at least one embodiment of the writing utensil in detail, it is to be understood that the writing utensil is not limited in its application to the details of construction and to the arrangements of the components set forth in the following description or illustrated in the drawings. The writing utensil is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present writing utensil. It is important, therefore, that the claims be regard as including such equivalent constructions insofar as they do not depart from the spirit and scope of the present invention.

It is therefore an object of the present invention to provide a writing utensil which has all of the advantages of the prior art and none of the disadvantages.

It is another object of the present invention to provide a writing utensil which may be easily and efficiently manufactured and marketed.

It is another object of the present invention to provide a writing utensil which is of durable and reliable construction.

It is yet another object of the present invention to provide a writing utensil which is economically affordable and available to the buying public.

It is yet another object of the present invention to provide a writing utensil which provides additional benefits not present in the prior art.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a perspective view of the present invention.

### DESCRIPTION OF THE PREFERRED EMBODIMENT

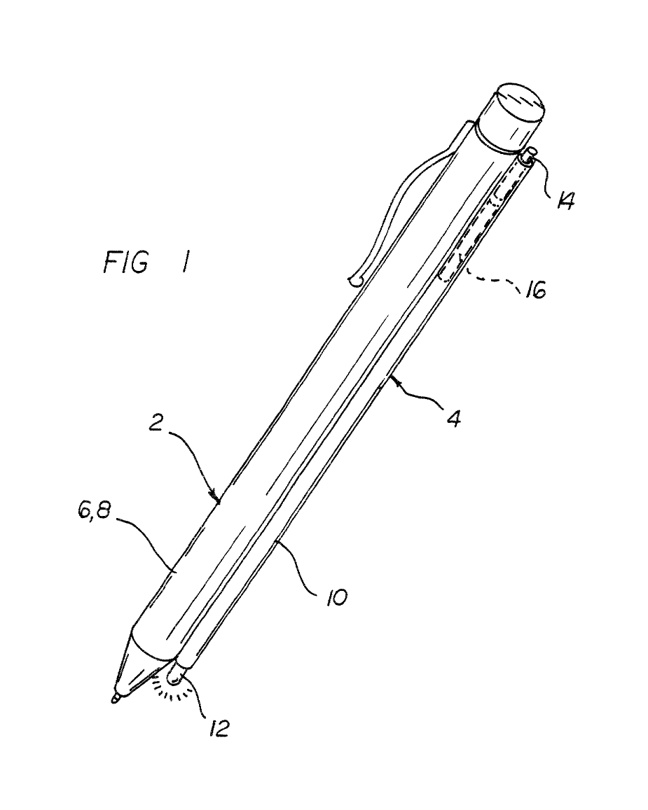

FIG. 1 shows a perspective view of the present invention. The present invention would comprise writing utensil 2 and attached flashlight 4. Writing utensil 2 would preferably be a pen 6, but a pencil 8 could also be utilized.

Writing utensil 2 would have two ends, a writing end and a terminal end. Flashlight 4 would be located in a thin tube 10 which would have two ends, a first end and a second end. The first end of the thin tube 10 of the flashlight 4 would be located near the writing end of writing utensil 2 and would have a light 12 attached. The second end of the thin tube 10 of the flashlight 4 would be located near the terminal end of writing utensil 2 and would have an on/off push button switch 14.

The flashlight would be powered by an internal battery 16. The internal battery 16 would be in contact with push button switch 14 to permit a user to turn on and off flashlight 4 with push button switch 14. The internal battery 16 would be located within an internal battery compartment that would either be located within the writing utensil 2 or within the thin tube 10. Push button switch 14 would serve as a circuit between the battery 16 within the battery compartment and the light 12.

What I claim as my invention is:

1. A writing apparatus for preparing writings in less-than-adequate lighting conditions comprising:
(a) a writing utensil with two ends, a writing end and a terminal end,
(b) a thin tube with two ends, a first end and a second end, the thin tube attached to the writing utensil, the first end of the thin tube attached to the writing utensil near the writing end of the writing utensil, the second end of the thin tube attached to the writing utensil near the terminal end of the writing utensil,
(c) a light attached to the first end of the thin tube,
(d) a battery compartment located within the writing apparatus, the battery compartment electronically connected to the light,
(e) a battery located within the battery compartment, and
(f) an external on/off switch located that serves as a circuit between the battery and the light.

2. A writing apparatus for preparing writings in less-than-adequate lighting conditions according to claim 1 wherein the writing utensil would be a pen.

3. A writing apparatus for preparing writings in less-than-adequate lighting conditions according to claim 1 wherein the writing utensil would be a pencil.

4. A writing apparatus for preparing writings in less-than-adequate lighting conditions according to claim 1 wherein the battery compartment would be located within the thin tube.

5. A writing apparatus for preparing writings in less-than-adequate lighting conditions according to claim 1 wherein the battery compartment would be located within the writing utensil.
